(19) United States
(12) Patent Application Publication
(10) Pub. No.: US 2026/0217557 A1
(43) Pub. Date: Jul. 30, 2026

(54) CATHODE MATERIAL COMPRISING IRON HYDROXY FLUORIDE

(71) Applicant: Belenos Clean Power Holding AG, Biel/Bienne (CH)

(72) Inventors: Julian BAUMGARTNER, Zürich (CH); Michael WORLE, Zürich (CH); Kostiantyn KRAVCHYK, Zürich (CH); Maksym KOVALENKO, Zürich (CH); Christoph GUNTLIN, Haslen (CH)

(73) Assignee: Belenos Clean Power Holding AG, Biel/Bienne (CH)

(21) Appl. No.: 19/144,728

(22) PCT Filed: Feb. 20, 2024
(86) PCT No.: PCT/EP2024/054309

§ 371 Date: Jun. 30, 2025

Related U.S. Application Data
(60) Provisional application No. 63/487,117, filed on Feb. 27, 2023.

(51) Int. Cl. C01G 49/00; H01M 4/02; H01M 4/58; H01M 4/62; H01M 10/0525

(52) U.S. Cl. CPC C01G 49/0018; H01M 4/582; H01M 4/625; H01M 10/0525; C01P 2002/72; C01P 2004/03; C01P 2004/04; C01P 2006/40; H01M 2004/021; H01M 2004/028

(57) ABSTRACT

The present invention relates to a method of producing a cathode active material, comprising at least partially dissolving iron fluoride trihydrate (IFH) in a polar solvent, thereby obtaining a solution; adding water to the solution, thereby precipitating a compound comprising pyrochlore iron hydroxy-fluoride hydrate (Pyr-IHFH); separating the precipitated compound from the solution; and heating the separated, precipitated compound to a temperature between 50 and 400° C., thereby obtaining the cathode active material comprising pyrochlore iron hydroxy-fluoride (Pyr-IHF), wherein adding water to the solution converts IFH to Pyr-IHFH. The invention further relates to a cathode active material comprising Pyr-IHF, a cathode comprising the cathode active material and a battery comprising the cathode.

### TECHNICAL FIELD OF THE INVENTION

The present invention relates to a method of producing a cathode active material. The invention further relates to such a cathode active material, and cathodes and batteries comprising the cathode active material.

### BACKGROUND

When looking at stationary batteries, a key challenge relates to achieving extended lifespan and reliability at a reasonable cost. Stationary batteries play a pivotal role in renewable energy integration, requiring long-term performance and minimal degradation over multiple charge-discharge cycles. Developing durable battery technologies that can withstand frequent use without significant capacity loss poses a challenge, especially when considering the economic constraints associated with stationary energy storage projects. Hence, there is a need for low-cost but high performing secondary (i.e. rechargeable) batteries in general, and in particular for stationary secondary batteries.

Exploring iron fluoride-based compounds, including iron (III) fluoride, iron (III) hydroxy-fluorides, iron (III) oxy-fluorides and iron (III) oxy-hydroxy-fluorides, as active material for the cathode in rechargeable batteries, in particular for lithium-ion batteries (LIBs), is promising due to the abundance and cost-effectiveness of iron. These compounds exhibit favourable electrochemical properties, offering high theoretical capacities, high oxidative stability and stable cycling, and for LIBs also high lithiation potentials.

Rhombohedral iron trifluoride with a hierarchized microporous/mesoporous texture from gaseous fluorination of iron disilicide, Delbègue, Guérin et al., E3S Web of Conferences 16, 08001 (2017) discloses stable low temperature r-FeF₃ for use in a cathode of a LIB, the r-FeF₃ having hierarchized channels of mesoporous/microporous texture favourable for lithium diffusion. Rhombohedral iron (III) trifluoride is obtained by the fluorination under pure fluorine gas of iron disilicide.

It is known that direct fluorination processes require the use of highly toxic, hazardous fluorination agents, and are therefore considered dangerous processes.

Chemistry and key structural features of oxyhydroxy-fluorides: relationships with the acidic character, thermal stability and surface area, Demourgues, Francke et al., Journal of Fluorine Chemistry, Volume 114, Issue 2 (2002), pp. 229-236 discloses iron hydroxy-fluoride having the hexagonal-tungsten-bronze (HTB)-type structure. The HTB-type structure provides small cavities suitable for adsorbing small molecules such as pyridine and ammonia.

However, the HBT-type structure may undergo short range structural changes in lithium ion batteries which reduce the Li-ion diffusion capacity and thus reduces the performance of the cathode and the battery.

A new form of FeF₃ with the pyrochlore structure: Soft chemistry synthesis, crystal structure, thermal transitions and structural correlations with the other forms of FeF₃, De Pape and Ferrey, Materials Research Bulletin, Volume 21, Issue 8 (1986), pp. 971-978 disclose iron (III) trifluoride with a cubic pyrochlore crystal structure (Pyr-FeF₃). The cubic pyrochlore structure provides large cavities formed from the corner-sharing FeF₆ octahedra. The pyrochlore crystal structure (Pyr-FeF₃) is capable of absorbing and desorbing small molecules, such as ammonia.

A disadvantage of Pyr-FeF₃ is that battery cells comprising a cathode comprising Pyr-FeF₃ as active material tend to have low or limited rate capabilities.

Synthesis by Thermal Decomposition of Two Iron Hydroxyfluorides: Structural Effects of Li Insertion, K. Lemoine, L. Zhang, et al., Chem. Mater. 2019, 31, 11, (2019), pages 4246-4257, disclose the synthesis of iron hydroxyfluoride, with both pyrochlore and HTB-type structure being present, from the thermal decomposition of Fe²⁺Fe³⁺F₅ (H₂O)₂ and Fe²⁺Fe₂³⁺F₈(H₂O)₂ under ambient air. The capacity was excellent but showed a significant decrease after the first charging/discharging cycle, leading to values of approx. 110 mAh g−1 upon cycling. This reduction is believed to be related to the amorphization of the pyrochlore network and the transformation of the HTB phase into the ReO3-type phase.

A disadvantage of this cathode active material is the limited use in secondary batteries, because the capacity drops already significantly after only one charging/discharging cycle due to deformations of the structures.

A further disadvantage of the foregoing methods is that they require the use of expensive, often hazardous and toxic compounds, rendering the cathode active material also expensive. Yet another advantage of the foregoing methods is that they allow limited control of the morphology of the produced cathode active materials, thereby leading to non-homogeneous performance.

Consequently, there is a need for a cheaper, safer and more environmentally friendly process of producing iron fluoride-based cathode active materials, especially in combination with keeping the cost of these cathode active materials low while maintaining a high and uniform performance when used in cathodes in batteries.

### SUMMARY OF THE INVENTION

It is an aim of the present invention to overcome one or more of the foregoing drawbacks. It is an aim of the present invention to provide a method of producing a cathode active material, which does not require the use of hazardous or toxic compounds. It is a further aim to provide a cheaper method, which is more environmentally friendly as compared to the methods known in the art. Yet another aim is a method that allows to control the morphology of the cathode active material produced, so as to increase the performance of the cathode active material, in particular the rate capability and cycling stability.

It is another aim of the present invention to provide a cathode active material for a cathode, the active material being cheaper than the materials known in the art, while having a performance, such as electrochemical performance and stability, being at least as good, and even better than those materials known in the art.

It is a further aim to provide cathodes and batteries which are cheaper than the ones known in the art, while having the same or even a better performance, in particular with regards to the lifetime, repeated charging/discharging of the battery (i.e. cycling stability), and the rate capability.

According to a first aspect of the present disclosure, there is provided a method of producing a cathode active material as set out in the appended claims.

The method comprises preparing a solution comprising a polar solvent and iron fluoride trihydrate (FeF₃·3H₂O, abbreviated as IFH). IFH is at least partially dissolved in the polar solvent. Advantages of the use of IFH as the precursor include that it is a cheap and commercially available compound.

With “at least partially dissolved” is meant that at least 10%, preferably at least 20%, more preferably at least 50%, most preferably at least 60%, for example at least 70%, at least 80%, at least 85%, at least 90%, or substantially all of IFH is dissolved in the polar solvent.

The method further comprises precipitating a compound comprising or substantially consisting of iron hydroxy-fluoride hydrate (Pyr-IHFH). Precipitating is achieved by adding water to the solution, thereby converting (dissolved) IFH in the solution to Pyr-IHFH.

The precipitated compound comprising or substantially consisting of Pyr-IHFH is then separated from the solution. Separating the precipitated compound from the solution can be performed by separation techniques known in the art, such as filtering, decantation or centrifugation.

In a next step, the separated, precipitated compound is dried at a temperature between 2° and 400° C., preferably between 5° and 400° C., more preferably between 10° and 300° C., such as between 20° and 280° C., thereby obtaining the cathode active material. The cathode active material comprises or substantially consists of pyrochlore iron hydroxy-fluoride (Pyr-IHF). In other words, drying removes at least partially, and substantially all water molecules from Pyr-IHFH, thereby obtaining Pyr-IHF.

Advantageously, the precipitated compound is dried by heating the precipitated compound to at a temperature between 10° and 400° C. at atmospheric pressure, preferably between 20° and 300° C. at atmospheric pressure, more preferably between 25° and 280° C. at atmospheric pressure. It will be understood that when the drying is performed at a reduced pressure, the temperatures required to obtain the same degree of water removal and thus conversion of Pyr-IHFH to Pyr-IHF will be lower than when drying is performed at atmospheric pressure.

Advantageously, the ratio of the weight of IFH to the volume of the polar solvent in the solution is between 0.002 and 0.1 g/mL, preferably between 0.003 and 0.05 g/mL, more preferably between 0.005 and 0.05 g/mL.

Advantageously, when water is added to the solution, between 1 and 15 vol. %, preferably between 1.5 and 10 vol. %, more preferably between 2 and 5 vol. %, such as 3 or 4 vol. % water is added to the solution, based on the volume of the polar solvent in the solution.

Advantageously, the polar solvent is one or more of an alcohol, ethylene glycole, glycerine or an acid. Non-limiting examples of suitable alcohols include ethanol, methanol or iso-propanol. A preferred polar solvent is ethanol.

Advantageously, Pyr-IHFH as comprised in the precipitated compound, has a cubic pyrochlore structure. Advantageously, Pyr-IHFH comprises channels having an average diameter between 2.5 and 5 Å, more preferably between 3 and 4 Å, such as between 3 and 3.8 Å, as calculated from X-ray diffraction (XRD) analysis.

Advantageously, the channels of IHFH are at least partially filled with water molecules.

According to a second aspect of the present disclosure, there is provided a cathode active material as set out in the appended claims.

The cathode active material comprises or substantially consists of pyrochlore iron hydroxy fluoride (Pyr-IHF). Advantageously, the cathode active material is obtained, i.e. manufactured or produced, by means of the method of the first aspect of the present disclosure.

Advantageously, Pyr-IHF comprised in the cathode active material comprises channels having an average diameter between 2.5 and 5 Å, more preferably between 3 and 4 Å, such as between 3 and 3.8 Å, as calculated from XRD analysis.

Advantageously, the cathode active material comprises or substantially consists of particles, wherein the particles comprise or substantially consist of Pyr-IHF. Advantageously, the particles comprising or substantially consisting of Pyr-IHF have an average diameter between 100 and 500 nm, preferably between 150 and 400 nm, more preferably between 175 and 300 nm, such as between 200 and 250 nm, as calculated from Transmission Electron Microscopy (TEM)-analysis.

According to a third aspect of the present disclosure, there is provided a cathode as set out in the appended claims.

The cathode comprises the cathode active material of the second aspect of the present disclosure.

Advantageously, the cathode further comprises carbon nanotubes (CNTs).

According to a fourth aspect of the present disclosure, there is provided a battery comprising the cathode of the third aspect of the present disclosure, and thus the cathode active material of the second aspect of the present disclosure.

Advantageously, the battery is a secondary battery. Advantageously, the battery is a lithium-ion battery.

### DESCRIPTION OF THE FIGURES

Aspects of the invention will now be described in more detail with reference to the appended drawings, wherein same reference numerals illustrate same features and wherein:

FIG. 1 schematically represents a method according to the invention;

FIG. 2 shows a SEM image of Pyr-IHFH;

FIGS. 3A and 3B show TEM images of Pyr-IHFH at different magnifications;

~ FIG. 4 shows a SEM image of Pyr-IHF;

FIGS. 5A and 5B show TEM images of Pyr-IHF at different magnifications;

FIG. 6 shows the particle size distribution (PSD) of a cathode active material of the invention;

FIG. 7A shows a HAADF STEM-image of Pyr-IHFH, and FIGS. 7B and 7C show HAADF STEM-images of Pyr-IHF at different magnifications;

FIGS. 8A and 8B show X-ray absorption spectroscopy (XAS)-analysis of Pyr-IHFH and Pyr-IHF in the X-ray absorption near edge structure (XANES) and the extended X-ray absorption fine structure (EXAFS) region, respectively;

FIGS. 9A and 9B show the charge and discharge voltage profile at moderate current rate for batteries of the invention with different electrolytes;

FIG. 10 shows the charge and discharge capacities and Coulombic efficiencies measured at a current density of 0.1 A/g_{AM} up to 250 charging/discharging cycles for batteries of the invention with different electrolytes;

FIG. 11 shows the rate capability of a battery of the invention measured at different current densities of 25-1000 mA/g_{AM};

FIG. 12 shows the charge and discharge voltage profiles measured at a current density of 0.1 A/g_{AM} for a further battery of the invention;

FIGS. 13A and 13B show the charge and discharge voltage profiles at high density of 1 A/g_{AM} for two batteries of the invention;

FIG. 14 shows the charge and discharge capacities and Coulombic efficiency at high current density of 1 A/g_{AM} up to 1000 charging/discharging cycles for a battery of the invention.

### DETAILED DESCRIPTION OF THE INVENTION

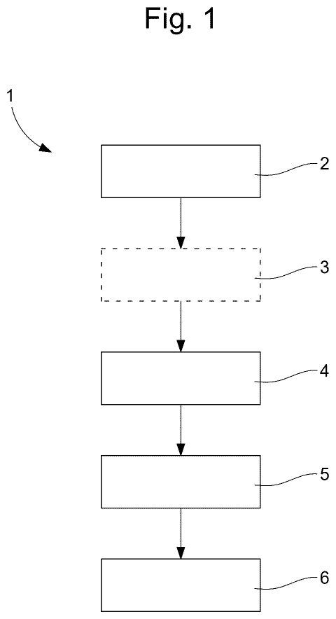

FIG. 1 schematically shows the production method 1 of a cathode active material, wherein the cathode active material comprises or substantially consists of pyrochlore iron hydroxy-fluoride (Pyr-IHF).

The method 1 comprises an operation 2 of preparing a solution, an operation 4 of precipitating a compound, an operation 5 of separating the precipitated compound, and an operation 6 of drying the precipitated compound. The method 1 further optionally comprises an operation 3 of removing any undissolved precursor from the solution.

The solution comprises a precursor at least partially dissolved in a polar solvent. The precursor is iron fluoride trihydrate (FeF₃·3H₂O, abbreviated as IFH).

Advantageously, the polar solvent is a liquid alcohol, preferably ethanol.

IFH can be dissolved in the polar solvent by means known in the art. A preferred example includes stirring the polar solvent to dissolve at least a portion of the IFH, wherein the polar solvent is at a temperature between 2° and 40° C., for example room temperature. It will be understood that the temperature should remain below the evaporation temperature of the polar solvent to avoid removal thereof from the (liquid) solution.

Optionally, the method comprises a removal operation 3 to remove any undissolved precursor from the solution. Removal can be performed by methods known in the art, for example by centrifugation and decantation, filtration or vacuum drying. This allows to reduce the waste of IFH to a minimum, thereby rendering the method of the present disclosure more environmentally friendly.

A compound is then precipitated in the solution by adding water to the solution. The precipitated compound comprises or substantially consists of iron hydroxy-fluoride hydrate (Pyr-IHFH). In other words, adding water to the solution converts at least a portion of the dissolved IFH into Pyr-IHFH.

The inventors have surprisingly discovered that the synthesis method is capable of being performed at the entire pH range. Advantageously, the water has a pH between 4 and 10, more preferably between 6 and 7. Advantageously, the water is distilled water.

After precipitation, the precipitated compound is separated from the solution during a separation operation 5. Separation can be performed by methods known in the art, for example by centrifugation and decantation, and/or by filtration.

Advantageously, Pyr-IHFH is present in the precipitated compound as particles, i.e. particles comprising or substantially consisting of Pyr-IHFH.

Advantageously, the particles have an average diameter between 200 and 250 nm, as calculated from TEM analysis. Advantageously, the particles are substantially spherical.

Advantageously, pyrochlore IHFH has a cubic pyrochlore structure. Within the pyrochlore structure of IHFH Fe(III) ions are surrounded by six anionic F/OH ligands on the same site 48f (mixed occupancy). The iron octahedra are corner-sharing forming 3D interconnected hexagonal channels aligned with the direction and equivalent directions.

Advantageously, the diameter of the channels in Pyr-IHFH is between 3 and 4 Å, such as 3.8 Å, as calculated from XRD analysis. Advantageously, the channels have a substantially hexagonal cross-section. Advantageously, the average diameter of the substantially hexagonal channels is defined as the distance between the pair of opposite F/OH ligands with the shortest distance between each other, projected onto the plane perpendicular to the direction along which channel propagates, i.e. the direction or equivalent directions.

The drying operation 6 advantageously comprises removing at least a portion, and substantially all, of the water molecules present within the precipitated compound, and in particular within the channels of Pyr-IHFH. Consequently, the drying temperature is selected so as to allow the removal of water molecules. For example, when the drying operation 6 is performed at atmospheric pressure, the temperature is advantageously at least 100° C., and preferably between 20° and 300° C., for example between 250 and 280° C. It will be understood that when the heating operation 6 is performed at a reduced pressure, a drying temperature can also be reduced accordingly to obtain the same result.

The drying operation can be performed by techniques and by heating apparatuses known in the art, for example in a tube furnace.

Advantageously, the precipitated compound is heated to the predetermined temperature for drying at a heating rate between 0.001 and 100° C./min, preferably between 0.1 and 50° C./min, more preferably between 1 and 25° C., for example between 5 and 10° C./min.

Advantageously, the precipitated compound is allowed to cool to room temperature at cooling rate between 0.001 and 100° C./min, preferably between 0.1 and 50° C./min, more preferably between 1 and 25° C., for example between 5 and 10° C./min, for example at a natural cooling rate.

Advantageously, the precipitated compound is dried for a duration between 1 and 120 minutes, preferably between 5 and 60 minutes, more preferably between 10 and 45 minutes, such as between 20 and 30 minutes. With “drying duration” is meant in the present disclosure the time during which the precipitated compound is dried once the preset drying temperature has been reached, i.e. excluding any heating up and cooling down time.

Alternatively or additionally, yet advantageously, the precipitated compound can be dried by means of supercritical fluid extraction, for example with, but not limited to, supercritical CO₂ (scCO₂). Advantageously, when drying through supercritical fluid extraction, the drying temperature can be as low as room temperature.

Upon completing the drying operation 6, the cathode active material is obtained. The cathode active material comprises or substantially consists of pyrochlore iron hydroxy-fluoride (Pyr-IHF).

Advantageously, Pyr-IHF is present in the cathode as particles, i.e. particles comprising or substantially consisting of Pyr-IHF. Advantageously, the average diameter and the shape of the particles comprising or substantially consisting of Pyr-IHF is substantially the same as the particles comprising or substantially consisting of Pyr-IHFH.

Advantageously, the particles comprising or substantially consisting of Pyr-IHF have an average diameter between 200 and 250 nm, as calculated from TEM analysis. More particularly, the particle diameter was determined by approximating the area of the particles, by an ellipsoid, and then calculating the diameter of the area-equivalent circle.

Advantageously, the particles are substantially spherical. With substantially spherical is meant in the present disclosure a shape which is spherical or close to spherical, for example elliptical with the length of the three axis to define the ellipsoid being within 20% of one another.

Advantageously, the particles have a narrow particle size distribution (PSD) as calculated from the diameters of the particles as calculated from TEM analysis. Advantageously, the PSD has one or more of a d₁₀-value equal to or lower than 210 nm, a d₂₅-value equal to or lower than 240 nm, a d₅₀-value equal to or lower than 265 nm, a d₇₅-value equal to or lower than 300 nm and a doo-value equal to or lower than 325 nm.

With a dₓ-value is meant that x % of the particles has a size equal to or smaller than the value. For example, for the cathode active material of the invention, a d₅₀-value equal to or lower than 265 nm means that 50% of the particles has a value equal to or lower than 265 nm.

Advantageously, Pyr-IHF comprises channels, i.e. 3D interconnected channels. Advantageously, the channels are formed by corner-sharing FeF₆₋ₓ(OH)ₓ octahedra of the pyrochlore structure of Pyr-IHF. Advantageously, the diameter of the channels in Pyr-IHF is between 3 and 4 Å, such as 3.8 Å, as calculated from XRD analysis.

Advantageously, Pyr-IHF further comprises pores within the particles. Advantageously, the pores have an average diameter between 1 and 5 nm, as indicated by TEM analysis.

The inventors have surprisingly discovered that the methods of the present disclosure allow to obtain particles having a well-controlled morphology—in particular the presence of channels and the shape of the particles—as well as an average diameter, which is considered optimal for preparing cathodes with the cathode active material, and a narrow particle size distribution. Prior art methods typically obtain particles having a large particle size distribution, which indicates a lack of homogeneity. Further, with prior art methods, the particles obtained are typically having average diameters below 50 nm or in the micrometre range. However, particles having an average diameter below 50 nm are known to lead to excessive CEI formation, whereas micrometre-range particles typically result in poor electronic or ionic diffusion.

The invention further relates to cathodes comprising Pyr-IHF as cathode active material.

Advantageously, the cathode further comprises a conductive compound, which can be any cathode-suitable conductive compound known in the field. Particularly preferred examples, albeit non-limiting, of conductive compounds include carbon black, CNTs and graphene. Alternatively or additionally, yet also alternatively, the conductive compound is a carbon coating applied to the surface of the active material (Pyr-IHF).

The inventors have surprisingly discovered that when CNTs are added to the conductive compound and thus to the cathode, the overall capacity of a battery comprising the cathode can be improved. Further, the Coulombic efficiency can be improved, presenting values close to 100% even after repeated charging and discharging.

Without wishing to be bound by any theory, the inventors believe that the CNTs improve the electronic conductivity within the conductive network of the cathode, thereby improving the reversible capacity of the material.

Advantageously, the cathode further comprises a cathode current collector, which can be any cathode current collector known in the field.

The present invention further relates to batteries, in particular lithium-ion batteries, comprising the inventive cathodes. Advantageously, the (lithium-ion) battery is a secondary (lithium-ion) battery.

The battery further comprises an anode. The anode can be any anode known in the field. Advantageously, the anode comprises an anode current collector, which can be any anode current collector known in the field.

The battery further comprises an electrolyte. The electrolyte can be a liquid electrolyte or a solid electrolyte. The electrolyte can be any electrolyte known in the art, such as electrolytes comprising lithium lanthanum zirconium oxide (Li₇La₃Zr₂O₁₂, LLZO), optionally doped, ionic liquid electrolytes, sulphide electrolytes and conventional carbonate electrolytes. Non-limiting examples of suitable electrolytes include LLZO, doped LLZO, LiPF₆-ethylene carbonate (EC)/dimethyl carbonate (DMC) (a conventional carbonate electrolyte), lithium bis(fluorosulfonyl)imide (LiFSI) in EC/DMC, LiFSI in dimethyl ether (DME), lithium bis(trifluoromethylsulfonyl)imide (LiTFSI) in 1-butyl-1-methylpyrrolidinium bis(trifluoromethylsulfonyl)imide (Pyr_{1,4}TFSI) (an ionic liquid electrolyte), LiFSI in Pyr_{1,4}TFSI, LiFSI in 1-propyl-1-methylpyrrolidinium bis(trifluoromethylsulfonyl)imide (Pyr_{1,3}TFSI).

The battery can further comprise a separator, in particular when the electrolyte is a liquid electrolyte. The separator can be any separator known in the field, for example a glass-fibre separator.

Without wishing to be bound by any theory, the inventors believe that diffusion of ions, in particular lithium ions when the battery is a lithium-ion battery, in the cathode takes place by diffusion through the channels of Pyr-IHF in the cathode.

Advantageously, the presence of nanometer-sized pores (1 to 5 nm, according to TEM analysis) in the Pyr-IHF particles further allows to improve the electrochemical performance of the battery. The inventors believe that this is because the electrolyte, for example a lithium-ion comprising electrolyte when the battery is a lithium-ion battery, can penetrate into the pores of Pyr-IHF, thereby decreasing the ionic diffusion pathways.

### EXAMPLES

### Example 1

The dissolution of iron fluoride trihydrate (FeF₃·3H₂O, abbreviated as IFH) in ethanol was tested by varying the weight of IFH and the volume of ethanol. Table 1 presents the different combinations tested, as well as the amount of IFH that was dissolved, expressed as % by weight based on the total weight of the solution. It is clear that the amount of IFH that dissolves in ethanol increases with increasing volume of ethanol.

TABLE 1
dissolution of IFH in ethanol

| IFH (g) | Ethanol (mL) | Wt. % IFH dissolved |
|---|---|---|
| 1 | 15 | 10 |
| 1 | 150 | 66 |
| 0.5 | 150 | 85 |

### Example 2

1 g IFH was dissolved in 15 mL ethanol at room temperature via stirring, leading to a yellow suspension of partially dissolved IFH in ethanol. The undissolved IFH was separated from the yellow suspension by centrifuging the suspension at 8000 rpm for 5 minutes, followed by decantation using a syringe. The clear, yellow solution was further filtered through a 0.45 μm polytetrafluoroethylene (PTFE) syringe filter. 0.6 mL distilled water (pH 6-7) was then added to the solution. A white product started to precipitate and the solution was left to precipitate at room temperature for at least 16 hours. Then, the precipitated product was separated from the solution by centrifugation at 10000 rpm during 5 minutes, followed by decantation, thereby obtaining Pyr-IHFH.

The obtained Pyr-IHFH was analysed both by scanning electron microscopy (SEM) and TEM. SEM measurements were performed with a Gemini 1530 microscope (Zeiss) operated at an acceleration voltage Uacc=1 KV. TEM measurements were performed with a Talos F200X (ThermoFisher Scientific, FEG, Uacc=200 kV).

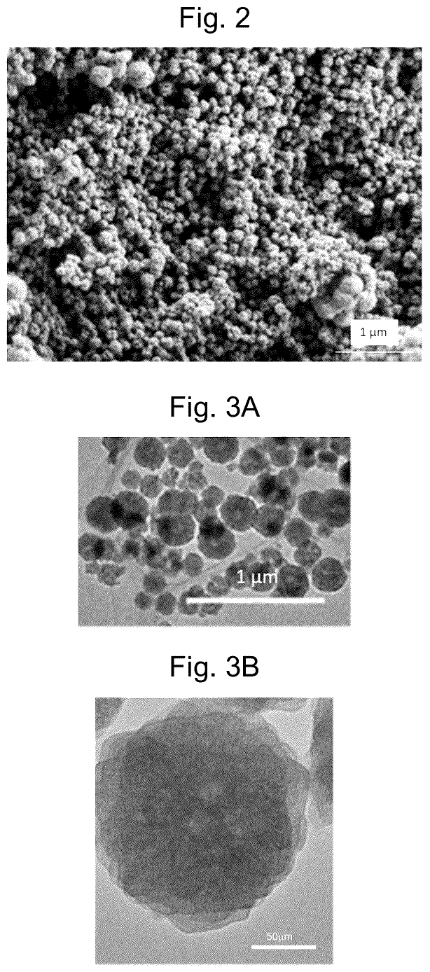

FIG. 2 shows the SEM image of the obtained Pyr-IHFH, from which spherical shapes are visible. FIGS. 3A and 3B show, at different magnifications, TEM images of the obtained Pyr-IHFH, from which it is clear that Pyr-IHFH is present as spherical particles having an average size of approx. 200 nm.

100 mg of the Pyr-IHFH was then placed in a 2 mL vial inside a tube furnace (Carbolite Gero), of which the sides were sealed with quartz wool. The furnace was heated at 10° C./min to 280° C., and was then kept at 280° C. for 30 minutes. Afterwards, the vial was let to cool down at a natural cooling rate. Pyr-IHF was obtained as an orange-brown powder.

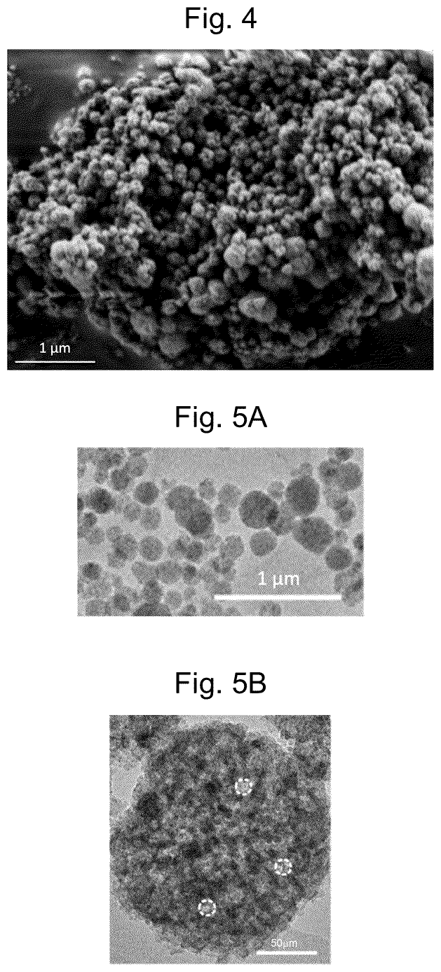

FIG. 4 shows the SEM image of the obtained Pyr-IHF, from which spherical shapes are visible. FIGS. 5A and 5B show, at different magnifications, TEM images of the obtained Pyr-IHF, from which it is clear that Pyr-IHF is present as spherical particles having an average size of approx. 200 nm. The average diameter was determined by approximating the area of the particles, by an ellipsoid, and then calculating the diameter of the area-equivalent circle.

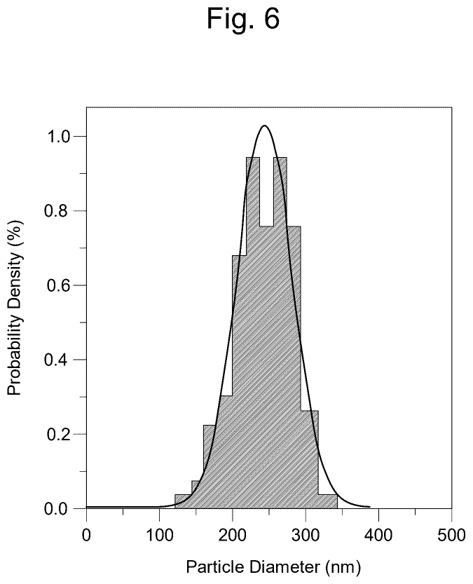

FIG. 6 shows the PSD of the particles, as calculated from the average diameters of the particles as calculated. The PDS had the following values, which indicate a narrow PSD in the field of particulate cathode active materials: d₁₀ of 194 nm, d₂₅ of 219 nm, d₅₀ of 245 nm, d₇₅ of 277 nm and d₉₀ of 290 nm.

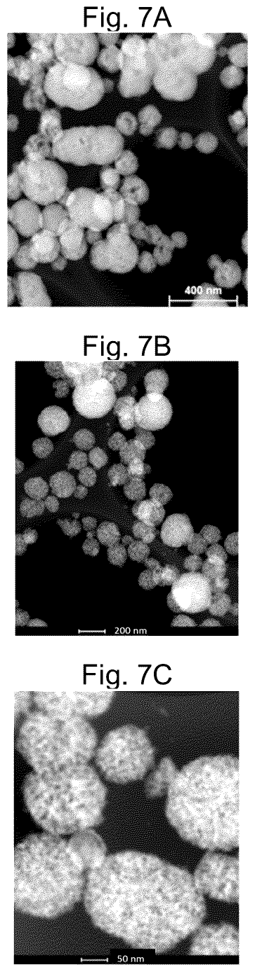

The surface roughness of the Pyr-IHFH and the Pyr-IFH particles was analysed by means of scanning transmission electron microscopy (STEM), in particular the high angle annular dark field (HAADF) STEM-images. It is clear that the surface roughness of Pyr-IHF particles (FIGS. 7B and 7C) is significantly different from that of Pyr-IHFH particles (FIG. 7A). From FIG. 7C, pores inside the Pyr-IHF particles are visible.

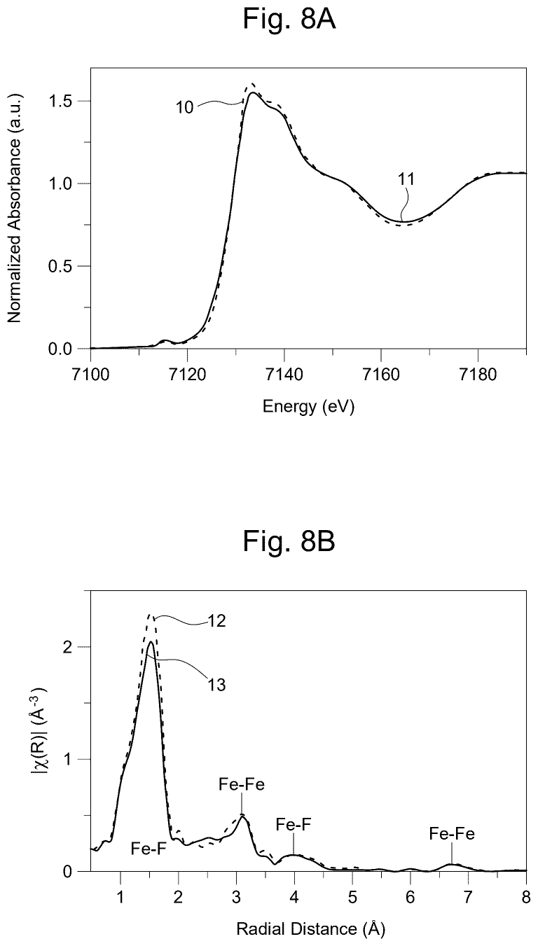

X-ray absorption spectroscopy (XAS) spectra were recorded in transmission mode at the Fe K-edge for both the obtained Pyr-IHFH and Pyr-IHF (BM31 beamline of the European Synchrotron Radiation Facility). The spectra were acquired at room temperature between 7.0 and 8.0 keV, scanning continuously with with ≈4 eV s−1, with 3 repeats and a final beam size of ≈6 mm×5 mm. FIG. 8A shows the normalized XANES region of Pyr-IHFH 10 and Pyr-IHF 11. FIG. 8B shows the k²-weighted EXAFS spectra in real space for Pye-IHFH 12 and Pyr-IHF 13. It is clear that Pyr-IHFH and Pyr-IHF show identical profiles in both the XANES and the EXAFS region, even up to the third coordination sphere at almost 7 Å, which indicates that the structure of interconnected channels is preserved during the heat treatment.

### Example 3

A cathode was prepared with pyrochlore iron hydroxy-fluoride of Example 2. To this end, a slurry was prepared by adding 100 mg Pyr-IHF (50 wt. %), 80 mg of carbon black (Super C65) (40 wt. %) as conductive additive, and 20 mg poly(vinylidene fluoride) (PVDF, 10 wt. %) in 2.4 g N-methyl-2-pyrrolidone (NMP).

The slurry was mixed under air in a beaker with 20 g of ZrO₂ balls (diameter 5 mm) and ball milled in a planetary ball mill (Fritsch, Pulverisette 7) for 1 h at 300 rpm. Then, the slurry was tape-casted onto carbon-coated Al foil with a doctor blade of 100 μm at a speed of 1 mm s⁻¹ to obtain a uniform tape of ca. 6 cm×30 cm. The tape-casted Al foil was dried under air at 80° C. until visibly dry (ca. 4 h), and was then dried under vacuum at 80° C. for 24 h. Disks with a diameter of 12 mm were punched out of the foils, weighed (each disk had an active material loading of 0.4-0.7 mg/cm²) and transferred into an argon-filled glovebox.

Lithium-ion coin cells were prepared in the argon-filled glovebox. Elemental lithium coins (diameter 12 mm) were used as counter and reference electrodes. A glass-fibre separator was placed in between the two electrodes and impregnated with 150 μL of lithium ion-conducting electrolyte. Two electrolytes were tested: a conventional carbonate electrolyte (1 M LiPF₆-EC/DMC) and an ionic liquid electrolyte (1 M LiTFSI in Pyr_{1,4}TFSI). The coin cell was then heated under argon for 24 h at 75° C. to ensure a good wetting.

The coin cell was electrochemically tested by galvanostatic cycling in a voltage range between 2-4.2 V vs. Li⁺/Li at room temperature and at a 100 mA/g_{AM} current rate on a multichannel potentiostat/galvanostat (Biologic (MPG2)).

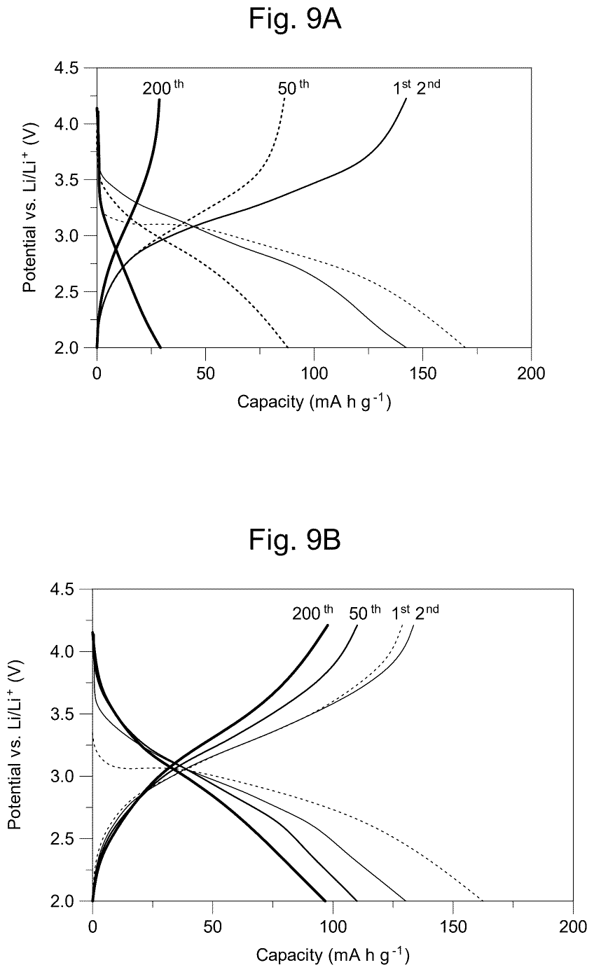

FIGS. 9A and 9B show the charge and discharge voltage profile for the battery with 1 M LiPF₆-EC/DMC and 1 M LiTFSI in Pyr_{1,4}TFSI as electrolyte, respectively, for the first, second, 50^{th} and 200^{th} charging/discharging cycle.

During the first discharge in EC/DMC electrolyte, a discharge capacity of 171 mA h g_{AM}⁻¹ is achieved, whereas in the ionic liquid (IL) electrolyte the discharge capacity was 163 mA h g_{AM}⁻¹. During the first charge, a capacity drop of approx. 30 mA h g_{AM}⁻¹ is observed with both electrolytes. The capacity during second discharge is 142 mA h g_{AM}⁻¹ in EC/DMC electrolyte and 130 mA h g_{AM}⁻¹ in IL electrolyte. For those reasons, the first cycle was subsequently considered as a precycle and capacity retentions were calculated relative to the second cycle.

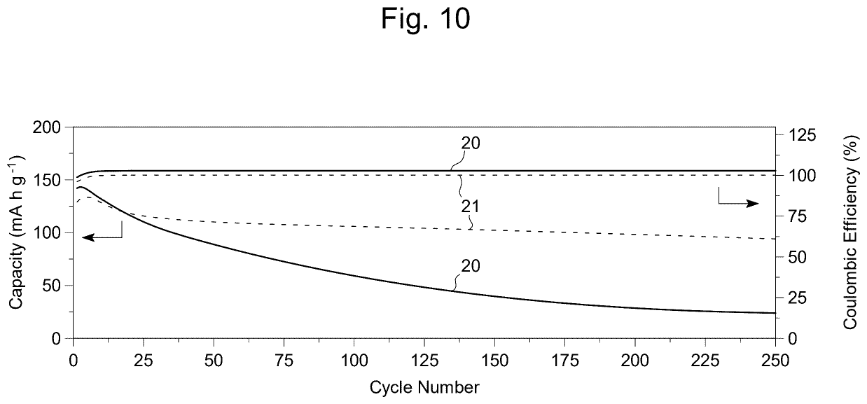

In subsequent cycles, the capacity for the cells employing EC/DMC electrolyte quickly drops, while the IL electrolyte shows much higher capacity retention, indicating a poor cycling stability of the cells with EC/DMC electrolyte. This is also visible from the Coulombic efficiency. FIG. 10 shows the capacity and Coulombic efficiency of the coin cells with EC/DMC electrolyte 20 and IL electrolyte 21 for up to 250 cycles. Only 16% of the initial charge capacity of Pyr-IHF-containing cathodes measured in the EC/DMC electrolyte 20 was retained after 250 cycles. On the contrary, cells with IL electrolyte 21 showed superior capacity retention of Pyr-IHF cathodes of 73% after 250 cycles under identical conditions. The consistently good coulombic efficiencies of 99.7% after the first cycle further demonstrates superior cycling stability in IL-based electrolytes, such as electrolyte 21.

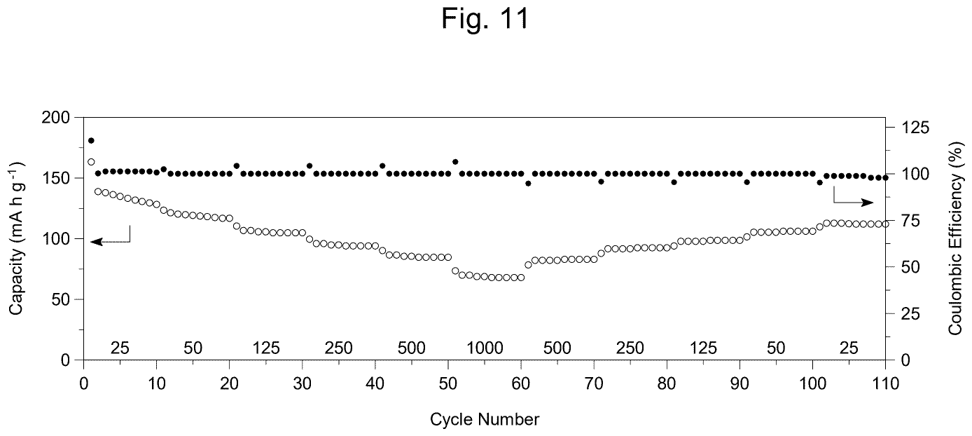

FIG. 11 shows the rate capability of the coin cell with IL electrolyte. The discharge capacity drops by approx. 50% between the 10th and 60th cycle when the current was increased from 25 to 1000 mA g_{AM}⁻¹. When the current rate was reduced to 25 mA g⁻¹, most of the capacity was recovered (128 mA h g_{AM}⁻¹ for the 10th cycle vs 110 mA h g_{AM}⁻¹ for the 110^{th} cycle).

### Example 4

A further cathode was prepared with pyrochlore iron hydroxy-fluoride of Example 2. To this end, a second slurry was prepared by adding 100 mg Pyr-IHF (50 wt. %), 78 mg of carbon black (Super C65) (39 wt. %) and 2 mg of CNTs (1 wt. %) as conductive additive mixture, and 20 mg poly(vinylidene fluoride) (PVDF, 10 wt. %) in 2.4 g N-methyl-2-pyrrolidone (NMP).

A cathode and a battery cell were prepared with this second slurry in the same way as elaborated in Example 3 for the cathode without any CNTs. As electrolyte, only the ionic liquid electrolyte (1 M LiTFSI in Pyr_{1,4}TFSI) of Example 3 was used.

The coin cell was electrochemically tested by galvanostatic cycling in a voltage range between 2-4.2 V vs. Li⁺/Li at room temperature on a multichannel potentiostat/galvanostat (Biologic (MPG2)).

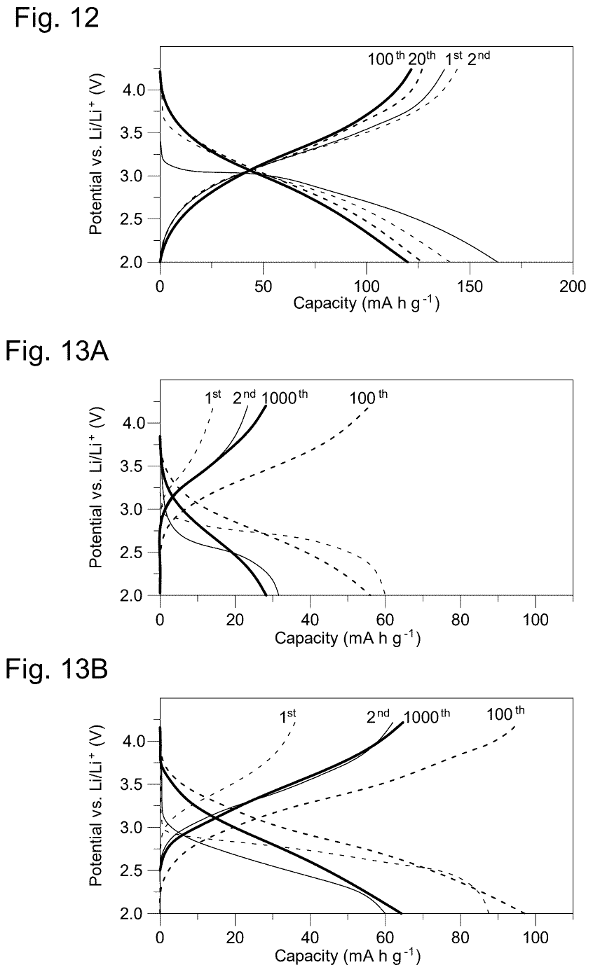

FIG. 12 shows the charge and discharge voltage profile when tested at a 100 mA/g_{AM} current rate for the battery with CNTs for the first, second, 20^{th} and 100^{th} charging/discharging cycle. When comparing to FIG. 9B (same battery cell but without CNTs), it is clear that the discharge capacity of the initial cycle is almost identical with (162 mA h g−1) and without CNTs (163 mA h g−1). However, the Coulombic efficiency (not shown) of the initial cycle is significantly closer to 100% (119.5% with CNTs vs. 126.2% without CNTs), indicating a higher reversibility in the presence of CNTs.

Galvanostatic testing was also performed at a 1 A/g_{AM} current rate for the batteries with and without CNTs. FIGS. 13A and 13B show the charge and discharge voltage profile for the first, second, 100th and 1000th charging/discharging cycle. It is clear that the overall capacity is significantly improved in the presence of CNTs. This indicates that electronic percolation was indeed limited at high current rates and can be mitigated by CNTs due to their high aspect ratio.

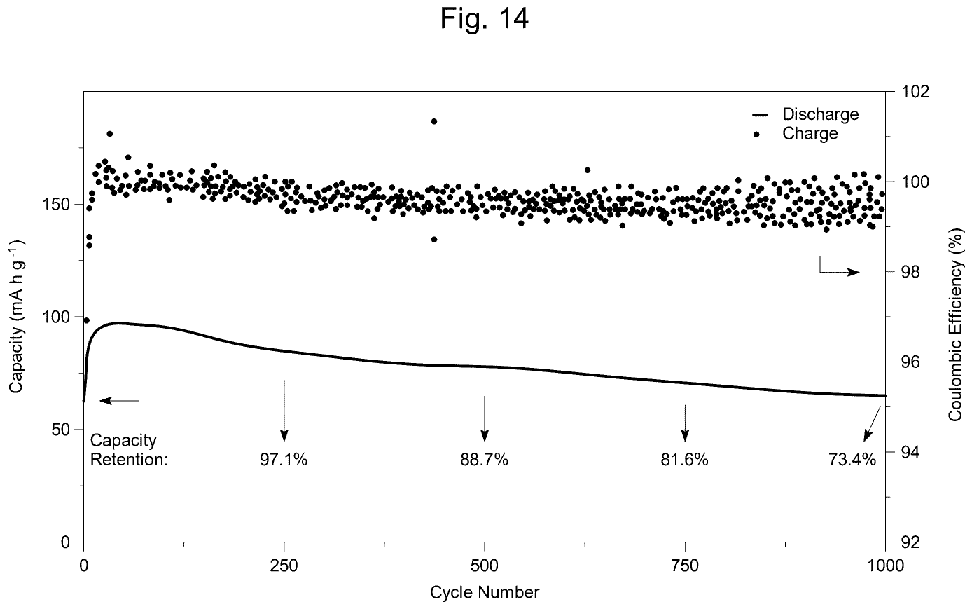

FIG. 14 shows the capacity and Coulombic efficiency for the battery comprising CNTs and cycled at a a 1 A/g_{AM} current rate. The Coulombic efficiency remains close to 100% even after 1000 charging and discharging cycles. Further, the capacity retention is very high: 90.1% after 400 cycles, 86.1% after 600 cycles and 79.1% after 800 cycles.

### NOMENCLATURE

1. Method of producing cathode active material
2. Solution preparation operation
3. Removal operation
4. Precipitation operation
5. Separation operation
6. Drying operation
10. Pyr-IHFH
11. Pyr-IHF
12. Pyr-IHFH
13. Pyr-IHF
20. Coin cell with EC/DMC electrolyte
21. Coin cell with ionic liquid electrolyte

1-16. (canceled)

17. A method of producing a cathode active material, comprising:
preparing a solution comprising a liquid alcohol and iron fluoride trihydrate (IFH), wherein IFH is at least partially dissolved in a polar solvent;
precipitating a compound comprising iron hydroxy-fluoride hydrate (Pyr-IHFH) by adding water to the solution;
separating the precipitated compound from the solution; and
drying the separated, precipitated compound to a temperature between 2° and 400° C., thereby obtaining the cathode active material,
wherein adding water to the solution converts IFH to Pyr-IHFH, and the cathode material comprises pyrochlore iron hydroxy-fluoride (Pyr-IHF).

18. The method according to claim 17, wherein the ratio of the weight of IFH to the volume of the polar solvent in the solution is between 0.002 and 0.1 g/mL.

19. The method according to claim 17, wherein between 1 and 15 vol. % water is added to the solution, based on the volume of the polar solvent in the solution.

20. The method according to claim 17, wherein the polar solvent is one or more of an alcohol, ethylene glycole, glycerine or an acid.

21. The method according to claim 17, wherein the precipitated compound is dried at a temperature between 10° and 400° C. at atmospheric pressure.

22. The method according to claim 17, wherein separating (5) the precipitated compound from the solution comprises one or more of centrifugation, decantation or filtering.

23. The method according to claim 17, wherein Pyr-IHFH comprises channels, wherein the channels have an average diameter between 2.5 and 5 Å, as calculated from X-ray diffraction (XRD) analysis.

24. The method according to claim 23, wherein the channels are at least partially filled with water molecules.

25. A cathode active material for a cathode, comprising pyrochlore iron hydroxy fluoride (Pyr-IHF).

26. The cathode active material according to claim 25, wherein Pyr-IHF comprises channels, wherein the channels have an average diameter between 2.5 and 5 Å, as calculated from XRD analysis.

27. The cathode active material according to claim 25, comprising particles comprising Pyr-IHF, wherein the particles have an average diameter between 100 and 500 nm, as calculated from Transmission Electron Microscopy (TEM)-analysis.

28. A cathode comprising the cathode active material according claim 25.

29. The cathode according to claim 28, further comprising carbon nanotubes.

30. A battery comprising the cathode according to claim 28.

31. The battery according to claim 30, wherein the battery is a secondary battery.

32. The battery according to claim 30, wherein the battery is a lithium ion battery.
